(19) United States
(12) Patent Application Publication
(10) Pub. No.: US 2003/0046615 A1
(43) Pub. Date: Mar. 6, 2003

(54) System and method for adaptive reliability balancing in distributed programming networks

(76) Inventor: Alan Stone, Morristown, NJ (US)

Correspondence Address: PILLSBURY WINTHROP, LLP, P.O. BOX 10500, MCLEAN, VA, 22102, US

(21) Appl. No.: 09/741,869

(22) Filed: Dec. 22, 2000

(51) Int. Cl. G06F 11/30

(52) U.S. Cl. 714/47

(57) ABSTRACT

Exemplary embodiments of the invention provide methods and systems for performing reliability balancing, based on past distributed programming network component history, which balances computing resources and their processing components for the purpose of improving the availability and reliability of these resources.

### 1. FIELD OF THE INVENTION

The present invention is related to reliability balancing in distributed programming networks. More specifically, the present invention is related to reliability balancing in distributed programming networks based on past distributed programming network and/or distributed programming network component history.

### 2. BACKGROUND OF THE INVENTION

Computing prior to low-cost computer power on the desktop, was organized in centralized logical areas. Although these centers still exist, large and small enterprises over time are distributing applications and data to where they can operate most efficiently in the enterprise, to some mix of desktop workstations, local area network servers, regional servers, web servers and other servers. In a distributed programming network model, computing is said to be “distributed” when the computer programming and data that computers work on are spread out over more than one computer, usually over a network.

Client-server computing is simply the view that a client machine or application can provide certain capabilities for a user and request others from other machines or applications that provide services for the client machines or applications.

Today, major software makers are fostering an object-oriented view of distributed computing. As a distributed publishing environment with Java and other products that help companies create distributed applications, the World Wide Web is accelerating the trend toward distributed computing. Distributed software models also lend themselves well to provide scalable, highly available systems for large capacity or mission critical systems.

The Common Object Request Broker Architecture (CORBA) is an architecture and specification standard for creating, distributing, and managing distributed program objects in a network. It allows programs at different locations and developed by different vendors to communicate in a network through an “interface broker.” The International Organization for Standardization (ISO) has sanctioned CORBA as the standard architecture for distributed objects (which are also known as network components).

The essential concept in CORBA is the Object Request Broker (ORB). ORB support in a network of clients and servers on different computers means that a client program (which may itself be an object) can request services from a server program or object without regard for its physical location or its implementation. In CORBA, the ORB is the software that acts as a “broker” between a client request for a service (e.g., a collection of cohesive software functions that together present a server-like capability to multiple clients; services may be, for example, remotely invokable by its clients) from a distributed object or component and the completion of that request. In this way, network components can find out about each other and exchange interface information as they are running. To make requests or return replies between the ORBs, a General Inter-ORB Protocol (GIOP) and, for the Internet, its Internet Inter-ORB Protocol (IIOP) are used. The IIOP maps GIOP requests and replies to the Internet's Transmission Control Protocol (TCP) layer in each computer.

Regardless of what framework or architecture is used in a distributed programming network, the first step in object-oriented programming is to identify all the objects utilized in a system to manipulate and how they relate to each other, an exercise often known as data modeling. Once an object has been identified, the identity of the object is generalized as a class of objects, the type of data it contains and any logic sequences that can manipulate the data are defined. A real instance of a class is called an “object” or, in some environments, an “instance of a class.” For load balancing and reliability balancing (explained herein), multiple instances of the same object may be run at various points within a distributed programming network.

There are two primary challenges to managing large-scale distributed programming systems. One is to maintain high levels of performance when demand for distributed programming network services is high. This challenge is often referred to as “load balancing” and requires balancing the allocation of a finite amount of distributed programming network resources (associated with the distributed programming network services) to larger than usual number of client requests. Often, large-scale distributed programming networks service large numbers of clients of its services. The statistical balancing of this load demand is both a commonly observed and well studied phenomena.

The other primary challenge is maintaining continuous operation of these large-scale distributed programming networks. This challenge may be referred to as “reliability balancing”. It is a well understood principal that larger-scale system are more likely to have faults, i.e., causes of service errors. Additionally, the larger the system, the more likely it is that faults will have more significant effects on the consumers of its services. For example, if a service requires resources that utilize or access more than one object, then a failure in any one of these objects may result in a system failure.

Conventionally, there are many approaches for solving load balancing issues of large-scale distributed programming networks. While none of them seem perfect, they have been effective in demonstrating their benefits. However, the challenge of providing distributed programming network reliability, i.e., maintaining operation of distributed programming network management, has matured less rapidly. Conventional methods and distributed programming networks for providing large-scale distributed programming network reliability vary. There are several primary techniques.

The most popular technique for providing large-scale distributed programming network reliability depends on entity, or object instance redundancy. This technique is also often referred to as “replication” and provides some degree of protection against component failures in large or critical systems by providing alternate instances of the same object or group of objects in hopes that when a primary instance of the object or group of objects fails, one or more alternate instances can resume service where the primary left off.

Another common technique, called N-version programming, relies on three or more different versions (implementation) of the same service (or object) running concurrently. Their operation is controlled through some lock-step controlling mechanism such that each of the parallel implementations run logically through the same sequencing without one proceeding ahead of the other for instance. At opportune points in time, the outputs of each of the three or more instances is voted upon. The expectation is that all three instances would report the same results for whatever computational task they are providing, hence no discrepancies should be identified. When there is a failure in an instance, this technique relies upon the presumption that the three different implementations would not likely have the same error; hence, the majority output of the other two instances is taken as the valid output and propagated to the next objects in the chain of processing. This technique is often used in life-support, mission critical, aerospace, and aviation. It is obviously quite expensive to build these types of systems as, literally, the system is developed differently at least three times. This technique is also often called triple modular redundancy (TMR).

While conventionally practiced methods of entity redundancy/replication and other approaches for providing reliability management have been largely successful in helping maintain high availability in distributed programming networks, they have some limitations. For example, they are largely static in the way that they manage their strategy in the protection against faults. This means they are unable to trend the failures in a system over time. They require human intervention or control to adjust which components are replicated and where they are replicated to. Moreover, redundancy/replication may be a costly way to protect against system faults and may not be entirely successful if all instances of a component suffer from a similar problem.

### BRIEF DESCRIPTION OF THE DRAWINGS

The exemplary embodiments of the present invention will be readily appreciated and understood from consideration of the following detailed description of the invention, when taken with the accompanying drawings, in which same numbered elements are identical and:

FIG. 1 illustrates a distributed programming network and components of an adaptive reliability balancing system designed in accordance with an exemplary embodiment of the invention;

FIG. 2 illustrates groups of graphical relationships representing failure groups that may be evaluated for their overall reliability ratings by the cost evaluator illustrated in FIG. 1;

FIG. 3 illustrates representations of five services each with their own reliability rating;

FIG. 4 illustrates a method for reliability balancing in accordance an exemplary embodiment of the invention; and

FIG. 5 illustrates a fault tolerance subsystem designed in accordance with an exemplary embodiment of the invention.

### DETAILED DESCRIPTION

As one result of the conventionally understood static or non-adaptive reliability balancing approach, large-scale distributed programming networks often fail to exhibit reliability characteristics, for example, problems, particular to the distributed programming networks, until the distributed programming networks are commissioned, i.e., in operation. Additionally, distributed programming networks and distributed programming network components often change over time because of extended use, resulting deterioration and/or environmental changes.

Moreover, distributed programming networks and distributed programming network components often age in different ways. For example, with regard to software within distributed programming networks or distributed programming network components, software may be upgraded or customized to a particular application after a distributed programming network has been commissioned. The same is true for specialized hardware components and components that are replaced post-commissioning as a result of damage, be it long-term use induced or incident related. Regardless of the cause for altering a distributed programming network configuration subsequent to commissioning, it should be appreciated that distributed programming networks and distributed programming network components may change, resulting in a distributed programming network configuration that is different from the distributed programming network configuration that was tested for reliability characteristics at the time of, or prior to, commissioning.

Additionally, distributed programming networks designed to be reliable, have long failure-times, i.e., times in which a failure will occur, by definition. As one result of this relationship, distributed programming network and distributed programming network component manufacturers often have limited time and experience in characterizing the reliability characteristics of the distributed programming network and/or distributed programming network components and providing solutions for resolving failures in the distributed programming network and/or distributed programming network components.

Further, distributed programming networks often have migratory component (i.e., software components that are able to migrate from one CPU or machine to another, without a client knowing about its migration; this migration may alter the performance and/or reliability attributes of the service provided by the component). Utilization of such migratory components creates an ever-changing view of a distributed programming network's dynamics and availability.

Accordingly, the methods and systems designed in accordance with the exemplary embodiments of the invention utilize a collection of metering and timing components that provide feedback to allow for the adaptive and dynamic calibration of a running distributed programming network. These methods and systems provide a mechanism that allows a distributed programming network to retain availability metrics across power and distributed programming network failures to provide cumulative reliability metrics of software and/or hardware resources included in the distributed programming network. Exemplary embodiments of the invention may provide continuous monitoring of a distributed programming network to provide dynamic reliability balancing.

One area of utility provided by systems and methods designed in accordance with exemplary embodiments of the invention relates to the ability to intelligently couple services and the consumers of those services such that there is an improved chance of assuring the best availability conditions for delivery or provisioning of services. The availability of a service may be calculated in various ways. For example, the availability of a service may be calculated as the Mean Time To Failure (MTTF) divided by the sum of the MTTF and the Mean Time To Repair (MTTR) (i.e., availability=MTTF/(MTTF+MTTR)).

The MTTF is the time from an initial instant to the next failure event. An MTTF value is the statistical quantification of service reliability. The MTTR is the time to recover from a failure and to restore service accomplishment. Service accomplishment is achieved when a module (e.g., one or more components working in cooperation) or other specified reference granularity acts and provides a service as specified. An MTTR value is the statistical quantification of a service interruption, which is when a module's (or other specified reference granularity) behavior deviates from its specified behavior.

In accordance with an exemplary embodiment, a method and/or system may utilize “live” or “real-time” data. As one result, the systems and methods designed in accordance with that exemplary embodiment may enable adaptation to changing characteristics of a distributed programming network in a real-time or near real-time manner. Such a capability may significantly improve a confidence of availability assurance in distributed programming networks that are expected to run for very long periods of time.

In accordance with an exemplary embodiment of the invention, adaptive reliability balancing may be performed in a distributed, client-server distributed programming network environment to provide for the pairing of a client and server software components in a distributed programming network such that each of them can meet or exceed their reliability goals. Systems and methods designed to provide this adaptive reliability balancing may provide the ability to adaptively balance the reliability in a distributed programming network in a way that is most appropriate given both the present configuration of the distributed programming network and the history of the components in the distributed programming network. Such systems and methods utilize balancing techniques with adaptive measures to perform reliability balancing based on the history and/or statistical prediction of future demand on the distributed programming network and/or distributed programming network services. Page: 8

The data accumulated is a historical perspective of the performance of the components participating in the system. That information may be used to try to provide predictive assumptions regarding future performance. For example, the MTTR for a component is likely to be relatively invariant because it corresponds to the time associated with creating a new component instance and initializing it for service. As a result, over time, the average of the MTTR for any specific component is generally a fairly confident number for use in the prediction of the repair interval for future failures of that component. The MTTF, on the other hand is likely to be less predictable and more stochastic. As a result, the availability of a system may change as a result of the potentially dynamic MTTF.

Because the components in a distributed programming network often rely on the participation of other components in the distributed programming network, the collective evaluation of all or a substantial number of the components participating is required to understand the reliability of the distributed programming network. As a result, systems and methods designed in accordance with an exemplary embodiment of the invention gather location, time, dependency, and/or reliability data relating to a particular distributed programming network. This data may then be analyzed by cost evaluation heuristics. The output of these heuristic functions may provide an optimal and/or most optimal choice of a distributed component to handle a request in a distributed programming network where there are a finite multiple of choices.

A user defined merit function may be applied to select a “best fit” based on user-defined constraints. Such a user defined merit functionPage: 9 can receive goal or constraint-based parameters as inputs to the function for guidance.

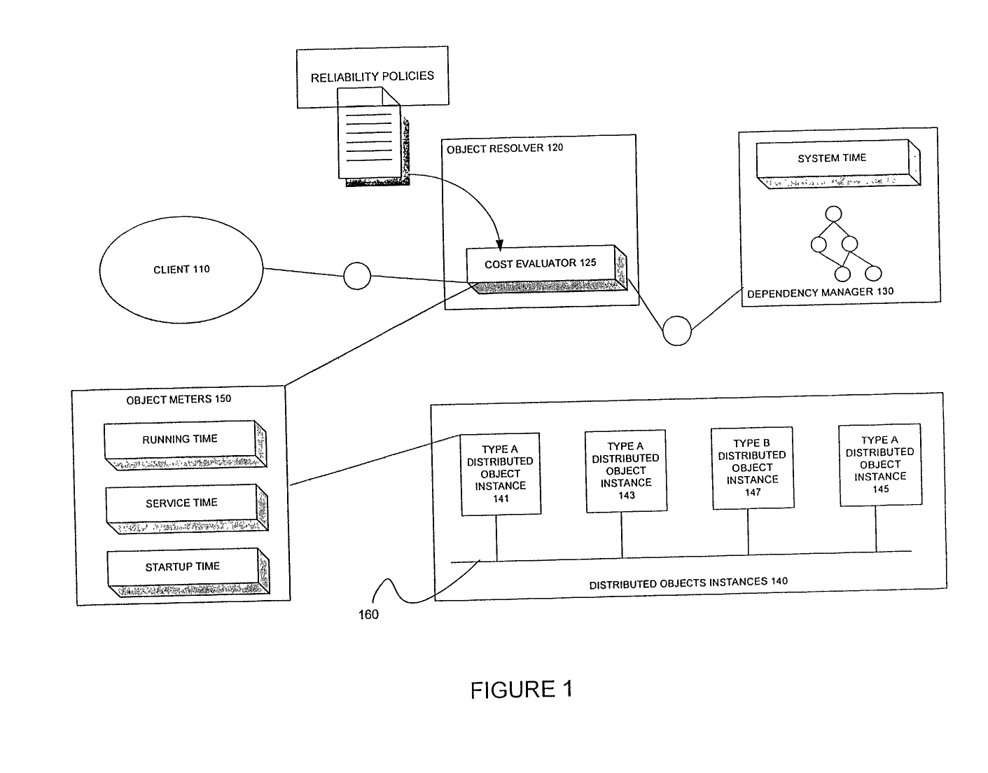

FIG. 1 illustrates a distributed programming network 100 and components of an adaptive reliability balancing system designed in accordance with an exemplary embodiment of the invention. As shown in FIG. 1, there are four primary participants: a client 110, an object resolver 120, a dependency manager 130, distributed object instances 140 and object meters 150.

FIG. 1 illustrates the fact that the client 110 may wish to use a service of type ‘A’. The collection of distributed object instances 140, e.g., connected via a control fabric (e.g., a local area network) 160, may offer three such type “A” object instances 141, 143, 145 and one type “B” object instance 147. FIG. 1 does not illustrate the physical boundaries of this scenario. The control fabric 160 may include, for example, hardware and software that implement communication and/or control paths between independently running components, which allow for the communication between the redundancy of these distributed programming network components (e.g., the object instances 140) in the distributed programming network 100, e.g., the IIOP of the CORBA framework. Hence, type A object instances 141, 143, and 145 may be included in one or more modules or located on one or more processing components, e.g., one or more cards in a chassis, one or more computers in one chassis, one or more processes in one computer, etc.

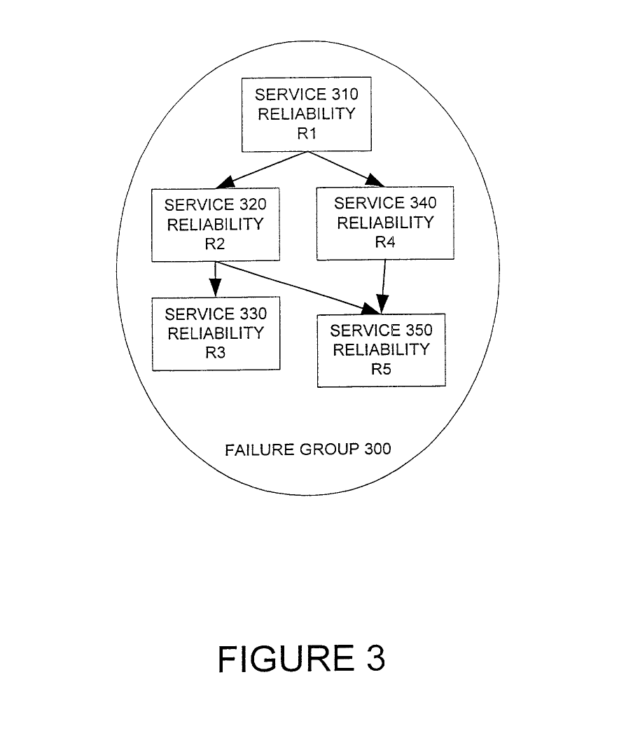

The client 110 may be, for example, an application or potentially a distributed object that seeks or has requested use of one or more services associated with one of one or more of the distributed object instances 140. For example, the client 110 may be an application that calls a function or method implemented in the type A distributed object instances 141, 143, 145 and/or the type B distributed object instance 147. In an embodiment of the invention, the client 110 generates or is assigned at least one reliability constraint that indicates the level of reliability expected by the client 110 (as explained below with reference to FIG. 3).

The object resolver 120 may be, for example, a service that returns an object reference indicating a particular object and instance of that object that meets the desired reliability constraints provided by the client 110.

The dependency manager 130 may be an object, service, or process that is knowledgeable regarding the topology and dependencies between the distributed object instances 140. For example, the dependency manager 130 may know that distributed object instances 141 and 143 are running on the same computer, are running on different computers, across the same processor or set of processors etc.

The distributed object instances 140 may be components that are used to provide services for one or more clients 110. A distributed object may be thought of as an object but characterized by the fact that the object is remotely (i.e., not running on the same processor) invokable from a client, e.g., client 110, through a network remoting mechanism. Each object instance 140 has a collection of properties or “meters”. These meters 150 may be cumulative over time. That is, the contents may be preserved in persistent and durable storage, then reinstated each time the object instance 140 is started.

The client 110 may confer with the object resolver 120 to obtain a reference to the optimal object instance 140 that meets the overall requirements for availability requested by the client. The object resolver 120 acts as an agent or broker on behalf of the client to try to find the best match requested of the client. If the object resolver is unable to fulfill the request, depending on the implementation, the object resolver may either return an indication to that effect or perhaps return the closet match short of meeting the requested parameters.

The overall network policies, including reliability policies, may be specified declaratively, e.g., through eXtensible Markup Language (XML) in the cost evaluator 125 included in the object resolver 120. The cost evaluator 125 may also utilize the dependency manager 130 to identify dependencies between the object instances 140, dependencies of the client 110 and the collection of possible type A instances.

The ability to identify and understand the dependencies between objects or services in the distributed programming network allows the dependency manager 130 to provide information regarding failure groups, i.e., groups of objects or services, in which failure of one of the constituent objects or services may lead to a fault. The information may be gathered dynamically, or through some prior declarative information (e.g., determined by another distributed programming network component, a component outside the distributed programming network, a user or administrator, etc.). The information may be represented by a directed graph. As explained below, this dependency information allows the cost evaluator 125 to compute the availability of a group. Larger groups (e.g., services/objects and their dependent services/objects) will likely have lower availability ratings; hence, they may be less likely candidates for a match between a client and a server when the highest availability measures are needed.

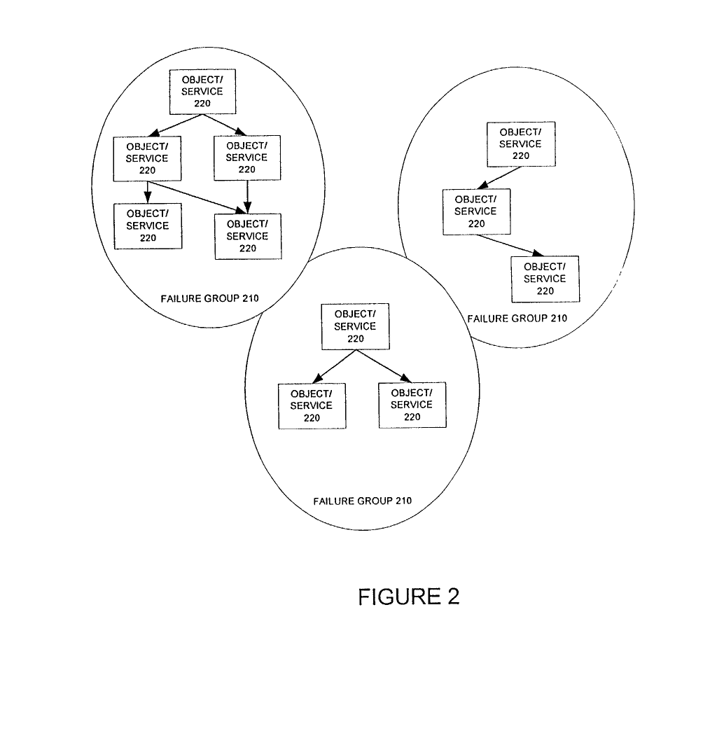

This dependency information may include an inventory of what each object or object instance is dependent on. Such an inventory could be represented, for example, by a graph. In one implementation, all dependencies may be depicted in the inventory. In another implementation, only the dependency between the software objects and client services is necessary to be depicted; thus, hardware and communications dependencies need not be captured. As illustrated in FIG. 2, when an entire distributed programming network is inventoried, a forest of directed graphs may result.

As shown in FIG. 2, the forest 200 (i.e., groups of graphical relationships 210) represents failure groups 210 that may be evaluated for their overall reliability ratings by the cost evaluator 125 illustrated in FIG. 1. The influence of each object/service 220 in each group 210 may be treated equivalently for simplicities sake; however, it is foreseeable also that the math for weighted influences may also be applied for a more accurate model. As a result, in one implementation of an exemplary embodiment of the invention, the dependency information may include weighted influence data that indicates the significance of various objects/services 220 of groups 210. It should be appreciated that these failure groups may be conceptually thought of as services (described above).

After receiving the data identifying the dependencies between the object instances 140, the cost evaluator 125 may evaluate the metrics associated with each of the object instances, e.g., 141, 143, 145 (explained in more detail below) and provided by the meters 150 to gather the necessary data to determine, for example, relative costs between the available choices of object instances to fulfill abinding session between the client and the object. The cost evaluator 125 may then apply the reliability and other policies, and select a “best fit”.

If the client 110 happens to be running on the same object instances 141 and 143, depending on the policy injected into the cost evaluator 125, it may be more desirable to return a reference to object instance 145 if the overall evaluation of reliability has a higher score than either instance 141 or 143.

Without the information provided by this evaluation, conventional systems merely used performance balancing or load balancing to determine which object instance to return. In contrast, systems and methods designed in accordance with the exemplary embodiments of the invention are based on an understanding that influence of object reliability on the overall availability of a distributed programming network is as significant and important as optimization of performance through conventional load balancing techniques.

The exemplary embodiments of the invention are based, in part, on a recognition that persistent accumulation of reliability metrics such as those provided by the meters 150 may be valuable in performing a reliability or availability determination. As one result of this recognition, various types of data may be utilized to effectively measure a lifetime view of a particular network's overall availability. To gather this data, the systems and methods have the ability to collect, accumulate, and persist this data over time in a reliable manner. The accumulation of service accomplishment information over the full lifetime or a significant period of the life of the distributed programming network helps provide meaningful and more accurate input into the heuristics that are responsible for an assessment of the overall distributed programming network availability.

Types of reliability metrics data that may be collected and accumulated for each individual distributed object may include, for example, sojourn time (i.e., the amount of time a particular service has been operating), service accomplishment time (i.e., the amount of time a particular service has been functional (e.g., able to provide its functions reliably)), and startup time (i.e., the amount of time it takes a particular service to start from a “cold boot” to being able to provide service; for simplicities sake, this metric may be a running average over the lifetime of the distributed programming network.) In addition, cumulative system time may be recorded to indicate an overall time the entire distributed programming network system has been running.

By recording these cumulative measurements, a more accurate understanding of the reliability of each service may be provided. Because, ideally, the reliability of any individual service is high, and hence the MTTF is ideally low, it is not valuable to “reset” these counters after every service creation, startup, or system reset. To the contrary, there is significant value in the information provided by these data types' long-term cumulative metrics.

The reliability metrics accumulated in the objects and services may be communicated back to the cost evaluator 125 in the object resolver 120. This may be accomplished any number of ways, for example, retrieving the reliability metrics on demand based upon requests for new use of a service.

When a client 110 requests the use of a service, the object resolver 120 first identifies the collection of all instances of the requested type available for service, e.g., service A corresponds to object instances 141, 143 and 145. The object resolver 120 is presumed to either include or have access to a directory of all the instantiated objects or services. Once a collection of candidate instances has been identified, the dependency manager 130 is consulted to identify the data identifying the dependencies between the objects and services. The object resolver 120 then queries or otherwise retrieves the reliability metrics from each object instance in turn, caching already visited objects from the same query for performance improvements.

Once all of the reliability metrics have been collected, the next step is to now perform some calculations to identify the overall availability of this group given its past performance.

After calculating the prospective cost, e.g., amount of resources expended, of each of the groups fulfilling the service request, the cost evaluator 125 then compares each of the groups to one another and performs a ranking. This ranking is based upon the reliability evaluation policies injected into the cost evaluator 125.

As an example, FIG. 3 illustrates five services 310, 320, 330, 340 and 350, each with their own reliability rating R1-R5 that are part of a failure group 300. Each of these reliability ratings may be specified in terms of the MTTF. Their reliability may then be specified as 1/MTTF. The object metrics provided by the meters 150 (illustrated in FIG. 1) may provide a good estimate of the availability as well. The availability derived from the object metrics counters is simply the (sojourn time)−(the service accomplishment time). The MTTR may be the rolling average object metric of the startup time, which may represent the amount of time required to go from a cold start to serviceability.

The availability of a distributed programming network may be conceptually quantified as the ratio of the service accomplishment to the elapsed time, e.g., the availability is statistically quantified as: MTTF/(MTTF+MTTR). The group availability is then the following:

$$a = \frac{{\prod }_{j = 1}^{N} {∝}_{ j}}{{\sum }_{j = 1}^{N} {∝}_{ j}}$$

where αⱼ represents the availability of each service in the group. The cost evaluator 125 may perform this function for each group, then, select the most appropriate group based on reliability policies (e.g., policies and criteria) specified in the cost evaluator 125. For example, one policy may be that the group of objects having a reliability value that is closest to the specified reliability goal is always chosen as opposed to the best or most reliable group of objects.

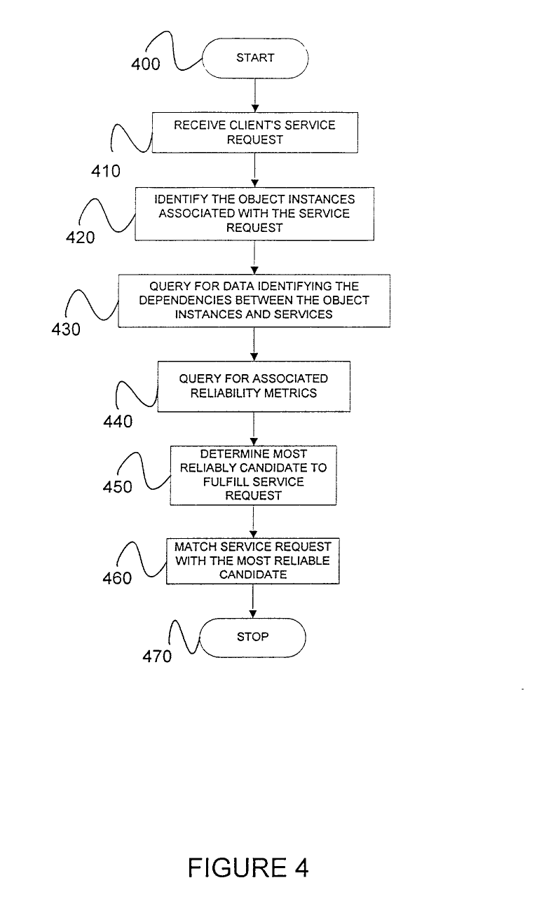

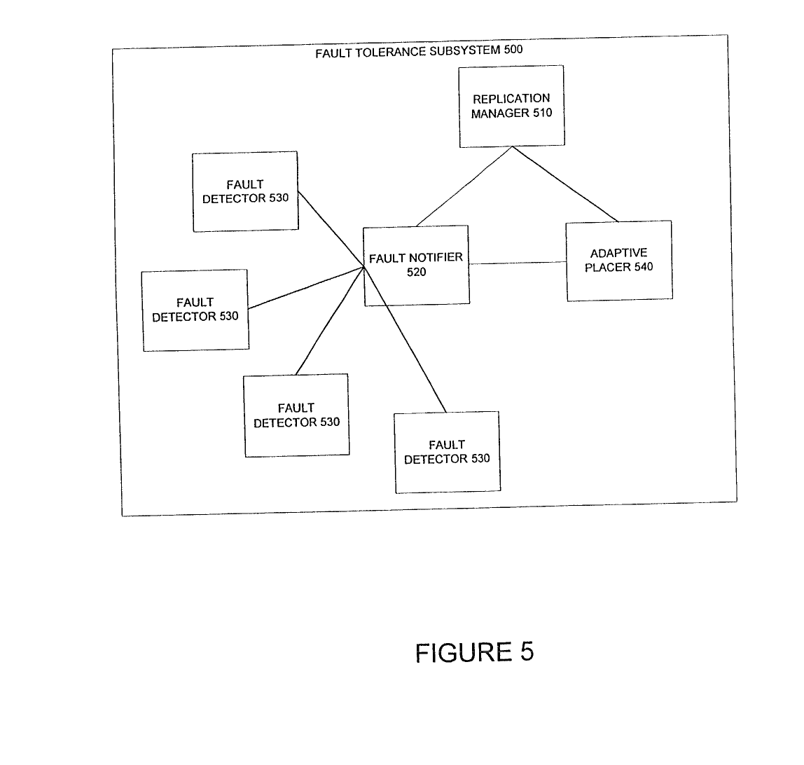

FIG. 4 illustrates a method for reliability balancing in accordance with the above-description. As shown in FIG. 4, the method begins at 400 and control proceeds to 410. At 410, a client's request for service is received by the distributed programming network. Control then proceeds to 420, at which the object resolver identifies the object instances associated with the requested service. Control then proceeds to 430, at which the object resolver queries the dependency manager for data identifying the dependencies between the objects instances and services. Control then proceeds to 440, at which the object resolver queries each object/service for its associated reliability metrics. Once the metrics for each failure group or set has been retrieved, the next step of evaluating the availability is considered. Control then proceeds to 450, at which a determination is made as to which object instance or group of object instances may most reliably fulfill the client's service request, based on the reliability metrics, dependencies and reliability policies included in or accessed by the cost evaluator. Control then proceeds to 460, at which this determination may be used by other distributed programming network components, as explained in relation to FIG. 5 below, that matches the client service request with the selected object or group of objects. Control then proceeds to 470, at which the method ends.

Methods and systems designed in accordance with the exemplary embodiments of the invention may be implemented, for example, in a subsystem that may be a CORBA-based, communication services system architecture.

One benefit of some distributed programming network architectures for systems providing hosted services using CORBA is that clients of the services may not know, nor care, whether or not resources are running in the same process, same host, an embedded card, or another machine connected via a network. The model entirely abstracts these particulars. One consequence of this architecture, because all services and resources provided by the distributed programming network are loosely coupled through a communications protocol (e.g., based on GIOP), the clients of these services, resources and CORBA objects have no knowledge of what hardware they are communicating with.

The methods and systems designed in accordance with the exemplary embodiments of the invention may be used in a distributed programming network designed in accordance with a distributed object model. All the standard mechanisms for locating objects in CORBA may apply in such a distributed programming network architecture. In addition, the distributed programming network architecture may extend the functionality to perform some specific functions that aid in performance and reliability scalability. In such a distributed programming network architecture, there may be, for example, two object locators, e.g., one that may be a standard Interoperable Naming Service (INS) and another that may be a system-specific object resolver such as object resolver 120 illustrated in FIG. 1. The object resolver 120 may use the INS along with other components to perform its task of providing automatic object reference resolution based on reliability and performance policies in the distributed programming network.

The INS may provide a repository for mapping service names to object references, which makes it easy for a client to locate a service by name without requiring knowledge of its specific location. With this architecture, a client can simply query the INS and have returned an object reference that can then be used for invocations. Located in the INS is a forest of object reference trees, an example of which is shown in FIG. 2. As a result, it should be appreciated that the dependency manager 130 may include or be included in the INS.

Most of the changes needed to include fault tolerance in a CORBA model are enhancements to the IIOP protocol and the addition of a few new CORBA object services. The components described above may be incorporated in such a fault tolerant system by implementing them as a fault tolerance subsystem 500 within a distributed processing network. As a result, the above-identified components and method operations may be incorporated in a network architecture that makes a CORBA fault tolerance infrastructure more autonomous.

As shown in FIG. 5, such a fault tolerance subsystem 500 may include a replication manager 510, fault notifier 520, at least one fault detector 530 and an adaptive placer 540, which is a system-specific component. Such a fault tolerance subsystem 500 may contain various services, e.g., those associated with the replication manager 510 (e.g., performing most of the administrative functions in the fault tolerance infrastructure and the property and object group management for fault tolerance domains defined by the clients of this service), the adaptive placer 540 (e.g., creating object references based on performance and reliability policies), the fault notifier 520 (e.g., acting as a failure notification hub for fault detectors and/or filtering and propagating events to consumers registered with this service), and the fault detector 530 (e.g., receiving queries from the replication manager, monitoring the health of objects under their supervision, etc.). The replication manager 510 is the workhorse of the fault tolerance infrastructure.

In a fault tolerant, distributed programming network based system designed in accordance with the exemplary embodiments of the invention, there are multiple candidates for hosting services. The adaptive placer 540 models these eligible candidates as a weighted graph that has performance and reliability attributes, e.g., the metrics provided by the object meters 150 illustrated in FIG. 1. The adaptive placer 540 may be the access point for the client, e.g., for client 110 illustrated in FIG. 1, providing a higher level of abstraction along with some system-specific features. The adaptive placer 540 may create data indicating the location of each object instance. It is then the cost evaluation heuristics (included in the cost evaluator 125 in the object resolver 120 illustrated in FIG. 2 each included in the adaptive placer 540 illustrated in FIG. 5) in the adaptive placer 540 that determines the best object instance to fulfill a client request based on object instance or object group performance (i.e., load balancing) and reliability (i.e., reliability balancing) coefficients.

The fault notifier 520 may act as a hub for one or more fault detectors 530. The fault notifier 520 may be used collect fault detector notifications and check with registered “fault analyzers” before forwarding them on to the replication manager 510. Thus the fault notifier 520 may provide the reliability metrics to the adaptive placer 540.

The fault detectors 530 are simply object services that permeate the framework in a relentless effort to identify failures of the objects registered in the object groups recognized by the replication manager 510. Fault detectors can scale in a hierarchical manner to accommodate distributed programming networks of any size. It should be appreciated that the fault detectors 530 may include, be included in or implement the object meters 150 illustrated in FIG. 1.

While this invention has been described in conjunction with the specific embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

We claim:

1. A method for performing reliability balancing in a distributed programming network, the method comprising:
receiving a service request;
identifying at least one object instance associated with the requested service;
querying for data identifying dependencies between the at least one object instance and the requested service;
querying for at least one reliability metric associated with the identified at least one object instance; and
determining which object instance will most reliably fulfill the service request based on that at least one reliability metric.

2. The method of claim 1, wherein determining which object instance will more reliably fulfill the service request is also based on dependencies between the at least one object instance and the requested service.

3. The method of claim 1, wherein determining which object instance will more reliably fulfill the service request is also based on reliability policies of the distributed programming network.

4. The method of claim 1, further comprising matching the service request with at least one object instance based on the determination of which object instance will most reliably fulfill the service request based on the at least one reliability metric.

5. The method of claim 4, wherein matching the service request comprises evaluating at least one reliability metric corresponding to at least one of a history and statistical prediction of future service demand on object instances included in the distributed programming network.

6. A system configured to perform reliability balancing in an operating distributed programming network, the system comprising:
an object resolver configured to identify at least one object instance associated with a requested service from a plurality of object instances coupled together via a control fabric, to query for at least one reliability metric associated with the identified at least one object instance and to make a determination as to which object instance will most reliably fulfill the service request;
a dependency manager coupled to the object resolver, the dependency manager being configured to provide data identifying dependencies between the at least one object instance and the requested service; and
at least one object meter configured to generate the at least one reliability metric regarding at least one object instance.

7. The system of claim 6, wherein the object resolver includes a cost evaluator that has access to reliability policies specific to the distributed programming network.

8. The system of claim 6, wherein the system is configured to retain availability metrics across power and system failures to provide cumulative reliability metrics corresponding to objects and object instances within the distributed programming network.

9. The system of claim 6, wherein the system performs continuous monitoring of the distributed programming network to provide dynamic reliability balancing.

10. The system of claim 6, wherein the system performs matching between service requests and objects to fulfill the service requests by evaluating the availability of at least one object instance to provide the requested service.

11. The system of claim 10, wherein the availability of the object instance is calculated based on a mean time to failure and a mean time to repair.

12. The system of claim 10, wherein the availability of the object instance is calculated as a mean time to failure divided by the sum of the mean time to failure and the mean time to repair.

13. The system of claim 12, wherein the mean time to failure is a time period from an initial instant to a next failure event.

14. The system of claim 13, wherein the mean time to failure is a statistical quantification of system service reliability.

15. The system of claim 12, wherein the mean time to failure is the time to recover from a failure and to restore service accomplishment.

16. The system of claim 15, wherein service accomplishment is achieved when objects working in cooperation to provide the requested service provide the requested service as specified.

17. The system of claim 12, wherein the mean time to repair is a statistical quantification of a service interruption.

18. The system of claim 6, wherein the object resolver evaluates real-time data regarding the operation of at least one object instance or group of object instances.

19. The system of claim 18, wherein the system enables adaptation of service request routing based on changing characteristics of the distributed programming network.

20. The system of claim 19, wherein adaptation is performed in real-time.

21. The system of claim 6, wherein the service request originates from an application or a distributed programming network object that seeks or has requested use one of one or more of the distributed objects.

22. The system of claim 6, wherein service request originates from a client, which generates or is assigned at least one reliability constraint that indicates a level of reliability expected by that client.

23. The system of claim 12, wherein the object resolver is a service that returns reference identification data indicating a particular object and instance of that object that meets the at least one reliability constraint provided by the client.

24. The system of claim 6, wherein the object resolver is a service that returns reference identification data indicating a particular object and instance of that object that meets the at least one reliability constraint provided in the service request.

25. The system of claim 6, wherein the dependency manager is a service that is knowledgeable regarding the topology and dependencies between distributed object instances included in the distributed programming network.

26. The system of claim 6, wherein the object resolver generates a reference to an optimal object instance that meets overall distributed programming network requirements.

27. The system of claim 26, wherein the overall distributed programming network requirements includes at least one reliability policy.

28. The system of claim 6, wherein the data identifying dependencies includes an inventory of what each object or object instance is dependent on.

29. The system of claim 6, wherein the at least one object meter generates at least one reliability metric that is cumulative over time.

30. The system of claim 6, wherein the at least one reliability metric includes or is based on a service sojourn time.

31. The system of claim 6, wherein the at least one reliability metric includes or is based on a service accomplishment time.

32. The system of claim 6, wherein the at least one reliability metric includes or is based on a startup time.

33. A fault tolerance subsystem for improving fault tolerance in a distributed programming network, the fault tolerance subsystem comprising:
a replication manager configured to perform object group management within a distributed programming network including a dependency manager being configured to provide data identifying dependencies between at least one object instance and a requested service;
at least one fault detector configured to receive and respond to queries from the replication manager and monitor a status of objects and object instances within the distributed programming network under the at least one fault detector's supervision and configured to generate the at least one reliability metric regarding at least one object instance within the distributed programming network;
a fault notifier coupled to the replication manager and the at least on fault detector and configured to act as a failure notification hub for the at least one fault detector by notifying the replication manager of object or object instance failure following receipt of data indicating detection of such a fault from the at least one fault detector; and
an adaptive placer configured to identify at least one object instance associated with a requested service from a plurality of object instances, to query for at least one reliability metric associated with the identified at least one object instance and to make a determination as to which object instance will most reliably fulfill the service request.

34. The fault tolerance subsystem of claim 33, wherein the object resolver includes a cost evaluator that has access to reliability policies specific to the distributed programming network.

35. The fault tolerance subsystem of claim 33, wherein the service request originates from a client, which generates or is assigned at least one reliability constraint that indicates a level of reliability expected by that client.

36. The fault tolerance subsystem of claim 35, wherein the object resolver is a service that returns reference identification data indicating a particular object and instance of that object that meets the at least one reliability constraint provided by the client.

37. The fault tolerance subsystem of claim 35, wherein the dependency manager is a service that is knowledgeable regarding the topology and dependencies between distributed object instances included in the distributed programming network.
